(19) United States
(12) Patent Application Publication
(10) Pub. No.: US 2026/0175918 A1
(43) Pub. Date: Jun. 25, 2026

(54) MOTOR VEHICLE WITH A WATER TANK AND A FLUID CONTAINER ACCESSIBLE THROUGH THE WATER TANK

(71) Applicant: AUDI AG, Ingolstadt (DE)

(72) Inventors: Sebastian ALBL, Weinböhla (DE); Stefan WELZ, Ingolstadt (DE)

(73) Assignee: AUDI AG, Ingolstadt (DE)

(21) Appl. No.: 19/394,146

(22) Filed: Nov. 19, 2025

(30) Foreign Application Priority Data
Dec. 19, 2024 (DE) 102024138827.7

(51) Int. Cl. B62D 25/08; B60H 1/28; B62D 25/24

(52) U.S. Cl. CPC B62D 25/081; B60H 1/28; B62D 25/24

(57) ABSTRACT

A motor vehicle with a combustion engine and/or electric drive. The motor vehicle has: a windshield; a water tank arranged in front of the windshield, which collects and drains water accumulating in a transition region between the windshield and a front hood. The water tank has a base element and a cover element which form an intake space for fresh air. The cover element and/or the base element has a baffle extending along the windshield with a baffle channel facing the windshield. An intake opening for fresh air is formed in the cover element, and a water collection basin with a base surface is formed in the base element. A fluid container with a filling section protruding into the intake space of the water tank is arranged below the cover element.

### FIELD

The invention relates to a motor vehicle with an internal combustion engine and/or electric drive, wherein the motor vehicle has: a windshield; a water tank arranged in front of the windshield, which is designed to collect and drain water accumulating in a transition region between the windshield and a front hood; wherein the water tank has a base element and a cover element, which form an intake space for fresh air; wherein the cover element and/or the base element have or partially form a baffle extending along the windshield with a baffle channel facing the windshield for draining water to both sides of the motor vehicle; wherein an intake opening for fresh air is formed in the cover element; and wherein a water collection basin with a base surface is formed in the base element.

### BACKGROUND

Such a motor vehicle with a water tank is described, for example, in the earlier application 10 2024 108 414 filed by the same applicant. Furthermore, reference is made to DE 195 46 085 C1 and DE 10 2018 201 866 A1.

Until now, known motor vehicles have had a sufficiently large prestige dimension to be able to provide a fresh air path suitable in terms of airflow parameters. The fresh air path is defined in particular by means of the components bulkheads (water tank base, water tank front wall, water tank cover), the end wall between the interior and the engine compartment and spring strut mounts. The fresh air should flow in the width direction of the vehicle through the jagged water tank, which has a depth in the vertical direction, to the outside (laterally) to a fresh air inlet of the air conditioning device or climate control unit in order to enable maximum water separation. The air conditioning unit is in particular arranged on the passenger side, depending on the steering, with the fresh air path also being designed from the driver to the passenger side, depending on the steering. In known water tanks it has been shown that a large amount of water is taken in through the intake opening in the water tank cover (cover element), which water is only separated inside the water tank.

Because of the so-called cab-forward design for increased interior volume and requirements regarding a flat front hood, an air path with sufficiently good flow parameters and water separation is no longer possible, in particular in the previous longitudinal and vertical extension. Furthermore, fluid containers, such as expansion tanks for cooling water or brake fluid, are often covered or difficult to access through the water tank.

### SUMMARY

The object of the invention is to provide a motor vehicle with a water tank in which the above disadvantages can be avoided, wherein reliable water separation and improved accessibility to the fluid containers are to be provided within a small available space.

A motor vehicle is thus proposed, with an internal combustion engine and/or electric drive, wherein the motor vehicle has: a windshield; a water tank arranged in front of the windshield, which is designed to collect and drain water accumulating in a transition region between the windshield and a front hood; wherein the water tank has a base element and a cover element, which form an intake space for fresh air; wherein the cover element and/or the base element have or partially form a baffle extending along the windshield with a baffle channel facing the windshield for draining water to both sides of the motor vehicle; wherein an intake opening for fresh air is formed in the cover element, and wherein a water collection basin with a base surface is formed in the base element. It is provided that a fluid container with a filling section protruding into the intake space of the water tank is arranged below the cover element and that an access opening to the filling section of the fluid container is formed in the cover element.

This allows the available installation space to be used optimally and access to a fluid container, in particular to its filling section, is made possible in such a way that removal of the water tank can be avoided.

In the motor vehicle, the fluid container may have a filling opening or a filling adapter on an upper side of the filling section, which can be reached through the access opening of the cover element. This makes it possible to connect a filler neck of a filling device to the filling opening or the filling adapter in order to fill up the fluid as required or to suck it out or remove it if necessary and to check the fill level manually if necessary.

In the motor vehicle, the base element in the region of the filling section can have wall sections which at least partially surround or enclose the filling section. As a result, a structure can be formed in the intake space around which the flow of air is possible without the air escaping from the intake space in the direction of the filling section or the fluid container.

In the motor vehicle, the wall sections can be formed integrally with the base element and form an inner contour that substantially corresponds to an outer contour of the filling section. In particular, a type of positive-fitting reception of the filling section in the base element or the wall sections is possible.

In the motor vehicle, the access opening can be closed by a removable cover element. This ensures that the intake space is reliably and essentially tightly closed, while access to the filling opening or the filling adapter is possible at any time. In particular, the cover element can also be movably connected to the cover element via a type of hinge or tab so that the cover element cannot be lost.

In the motor vehicle, a substantially annular wall can be formed between the base element, in particular the wall sections, and the cover element, such that air flowing through the intake space is guided around the annular wall between the base element and the cover element. As a result, a structure can be formed in the intake space around which the flow of air is possible without the air escaping from the intake space in the direction of the filling section or the fluid container.

In the motor vehicle, the annular wall can be designed to be flexible in terms of its material and/or its wall thickness. This ensures that adequate protection is provided in the event of an impact, particularly involving a pedestrian.

In the motor vehicle, the annular wall can be materially connected to the base element or formed integrally with it. In other words, the base element and the annular wall can be made of the same material, for example as an injection-molded component made of a plastic. However, it is also conceivable that the ring-shaped wall is made of a softer material than the base element. This enables improved tightness in a contact region between the annular wall and the cover element. It is also conceivable that the annular wall between the cover element and the base element is slightly compressed.

In the motor vehicle, the intake opening in the cover element can be arranged substantially centrally with respect to a vehicle width, and the access opening can be formed adjacent to the intake opening, wherein a spacing section of the cover element is formed between the intake opening and the access opening, which spacing section has an extent of less than 20 cm, in particular less than 5 cm, with respect to a vehicle width direction. In other words, the intake opening and the access opening can be very close to each other, although an extension of the spacing section from a few millimeters to about 3 cm is also conceivable.

### BRIEF DESCRIPTION OF THE FIGURES

Further advantages and details of the invention will become apparent from the following description of embodiments with reference to the figures. In the figures:

FIG. 1 shows a simplified and schematic plan view of a front part of a motor vehicle with windshield and water tank;

FIG. 2 shows a simplified and schematic perspective view of a front part of a motor vehicle with windshield and water tank;

FIG. 3 shows a simplified and schematic sectional view approximately corresponding to the section line III-III of FIG. 1A.

### DETAILED DESCRIPTION

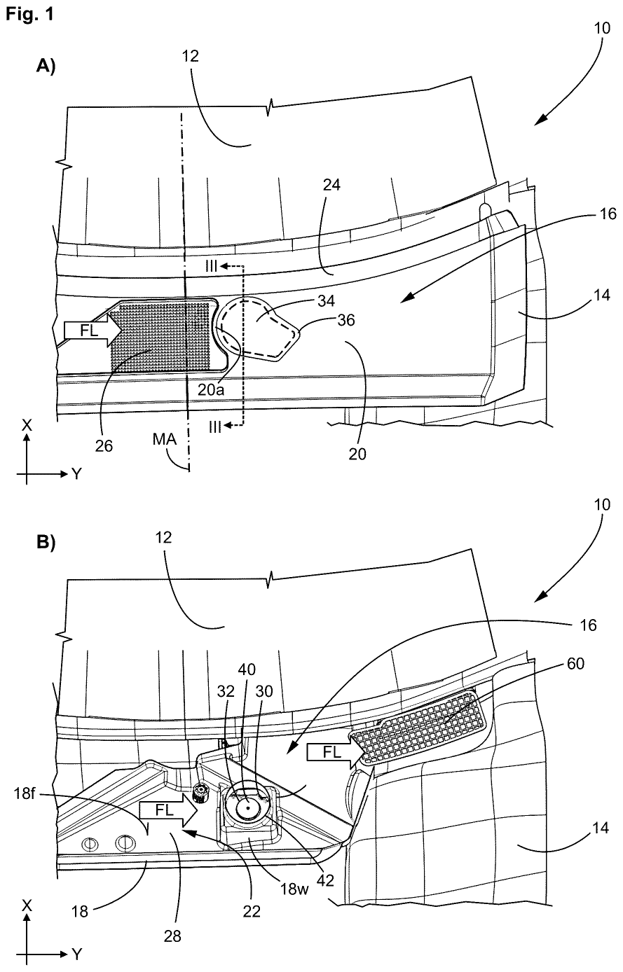

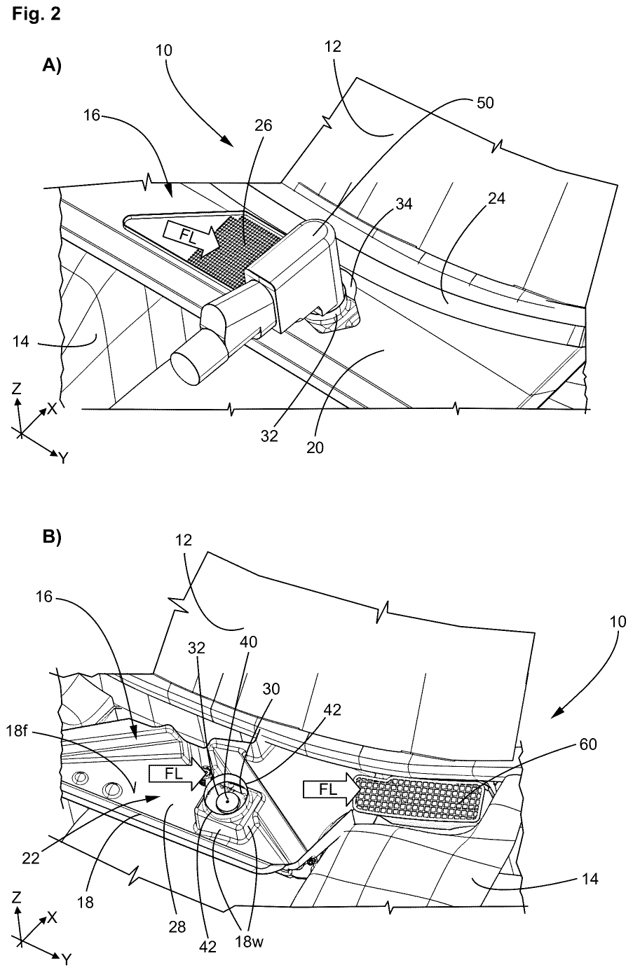

An example of a motor vehicle 10 with a water tank is described below with reference to FIGS. 1 and 2. In FIGS. 1 and 2, the motor vehicle 10 is represented in particular by its partially shown windscreen or windshield 12 and only by body parts 14 indicated in a grid-like manner.

The motor vehicle comprises a water tank 16 arranged in front of the windshield 12, which is designed to collect and drain water accumulating in a transition region between the windshield 12 and a front hood, which is not shown.

The water tank 16 has a base element 18, which can be seen particularly at B) in FIGS. 1 and 2. Furthermore, the water tank 16 has a cover element 20, which is shown in particular at A) in FIGS. 1 and 2. The cover element 20 is arranged on the base element 18 and between them an intake space 22 for fresh air is formed, which can be seen at B) in FIGS. 1 and 2, with the cover element 20 removed in these illustrations.

In this example, the cover element 20 has a baffle 24 running along the windshield 12 with a baffle channel facing the windshield 12 for draining water to both sides of the motor vehicle 10. It is pointed out that a baffle can also be provided or formed on the base element 18. Furthermore, it is also possible for the baffle to be formed jointly by the cover element 20 and the base element 18, wherein the cover element 20 and the base element 18 each comprise a part or section of the baffle. An intake opening 26 for fresh air F_{L} is additionally formed in the cover element 20. A water collection basin 28 with a base surface 28f is formed in the base element 18.

In the motor vehicle 10, a fluid container 30 with a filling section 32 protruding into the intake space 22 of the water tank 14 is arranged below the cover element 20. An access opening 34 to the filling section 32 of the fluid container 30 is formed in the cover element 20.

In FIG. 1, it can be seen at A) that the access opening 34 can be closed by a removable cover element 36.

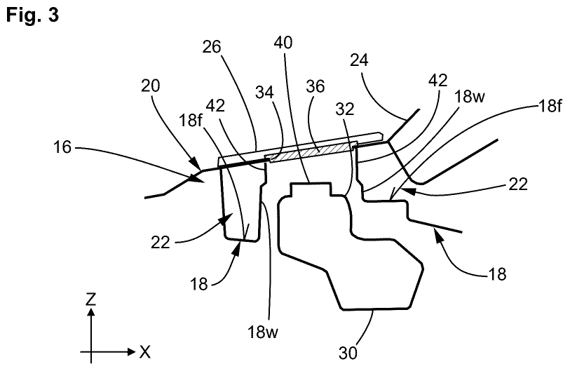

The further description now also refers to a simplified and schematic sectional view of FIG. 3, which corresponds approximately to a section line III-III of FIG. 1A. The reference numerals shown in FIG. 3 are the same as in the previously described FIGS. 1 and 2, so that the above explanations can also be used for FIG. 3.

The fluid container 30 has a filling opening 40 or a filling adapter on an upper side of the filling section 32, which can be reached through the access opening 34 of the cover element 30.

From FIG. 3 and at B) in FIGS. 1 and 2 it can be seen that the base element 18 has wall sections 18w in the region of the filling section 32 which at least partially surround or enclose the filling section 32. The wall sections 18w can be formed integrally with the base element 18 and form an inner contour that substantially corresponds to an outer contour of the filling section 32.

From FIG. 1 and B) in FIGS. 1 and 2 it can be seen that a substantially annular wall 42 is formed between the base element 18, in particular the wall sections 18w, and the cover element 20, such that air F_{L} flowing through the intake space 22 is guided around the substantially annular wall 42 between the base element 18 and the cover element 20.

The annular wall 42 can be designed to be flexible in terms of its material and/or its wall thickness. The flexibility of the annular wall 42 serves in particular to provide passive protection in the event of an impact, in particular of a pedestrian, on the motor vehicle 10, in particular on its front hood.

The annular wall 42 can, for example, be materially connected to the base element 18. It is also possible that the annular wall 42 is formed integrally with the base element 18, in particular from the same (plastic) material.

In particular with reference to FIG. 1, it can be seen at A) that the intake opening 26 in the cover element is arranged substantially centrally in the region of the longitudinal center axis MA with respect to a vehicle width (in the Y direction). The access opening 34 is arranged adjacent to the intake opening 26, wherein a spacing section 20a of the cover element 20 is formed between the intake opening 26 and the access opening 34, which has an extension of less than 20 cm, in particular less than 5 cm, relative to a vehicle width direction Y. The extension of the spacing section 20a can also be a few millimeters to a few centimeters, for example 0.5 cm to 3 cm.

From FIG. 2 at A) it is also evident that a filling neck 50 of a filling device not otherwise shown can be or is coupled to the filling section 32 or the filling opening 40 or a filling adapter. As a result, the fluid container 30 can be filled with a corresponding fluid, for example a coolant or a brake fluid.

Furthermore, with reference to FIGS. 1 and 2, it is pointed out that an air intake 60 for an air conditioning unit of the motor vehicle 10 is shown at B). Fresh air FL flows through the intake opening in the cover element 18 through the intake space 22 around the wall sections 18w and the annular wall 40 to the air intake 60.

With reference to FIG. 3, it is also pointed out that the fluid container 30 shown there is purely exemplary and can also have a different shape or a larger volume.

1. A motor vehicle with an internal combustion engine and/or electric drive, comprising:
a windshield;
a water tank arranged in front of the windshield, which is designed to collect and drain water accumulating in a transition region between the windshield and a front hood;
wherein the water tank has a base element and a cover element which form an intake space for fresh air;
wherein the cover element and/or the base element have or partially form a baffle running along the windshield with a baffle channel facing the windshield for draining water to both sides of the motor vehicle;
wherein an intake opening for fresh air is formed in the cover element; and
wherein a water collection basin with a base surface is formed in the base element;
wherein a fluid container with a filling section protruding into the intake space of the water tank is arranged below the cover element and an access opening to the filling section of the fluid container is formed in the cover element.

2. The motor vehicle according to claim 1, wherein the fluid container has a filling opening or a filling adapter on an upper side of the filling section, which can be reached through the access opening of the cover element.

3. The motor vehicle according to claim 1, wherein the base element in the region of the filling section has wall sections which at least partially surround or enclose the filling section.

4. The motor vehicle according to claim 3, wherein the wall sections are formed integrally with the base element and form an inner contour that substantially corresponds to an outer contour of the filling section.

5. The motor vehicle according to claim 1, wherein the access opening can be closed by a removable cover element.

6. The motor vehicle according to claim 1, wherein a substantially annular wall is formed between the base element, in particular the wall sections, and the cover element, such that air flowing through the intake space is guided around the substantially annular wall between the base element and the cover element.

7. The motor vehicle according to claim 6, wherein the annular wall can be designed to be flexible in terms of its material and/or its wall thickness.

8. The motor vehicle according to claim 6, wherein the annular wall is materially connected to the base element or is formed integrally therewith.

9. The motor vehicle according to claim 1, wherein the intake opening in the cover element is arranged substantially centrally in relation to a vehicle width, and in that the access opening is formed adjacent to the intake opening, wherein a spacing section of the cover element is formed between the intake opening and the access opening, which has an extension of less than 20 cm, in particular less than 5 cm, relative to a vehicle width direction.

10. The motor vehicle according to claim 2, wherein the base element in the region of the filling section has wall sections which at least partially surround or enclose the filling section.

11. The motor vehicle according to claim 10, wherein the wall sections are formed integrally with the base element and form an inner contour that substantially corresponds to an outer contour of the filling section.

12. The motor vehicle according to claim 2, wherein the access opening can be closed by a removable cover element.

13. The motor vehicle according to claim 3, wherein the access opening can be closed by a removable cover element.

14. The motor vehicle according to claim 4, wherein the access opening can be closed by a removable cover element.

15. The motor vehicle according to claim 2, wherein a substantially annular wall is formed between the base element, in particular the wall sections, and the cover element, such that air flowing through the intake space is guided around the substantially annular wall between the base element and the cover element.

16. The motor vehicle according to claim 3, wherein a substantially annular wall is formed between the base element, in particular the wall sections, and the cover element, such that air flowing through the intake space is guided around the substantially annular wall between the base element and the cover element.

17. The motor vehicle according to claim 4, wherein a substantially annular wall is formed between the base element, in particular the wall sections, and the cover element, such that air flowing through the intake space is guided around the substantially annular wall between the base element and the cover element.

18. The motor vehicle according to claim 5, wherein a substantially annular wall is formed between the base element, in particular the wall sections, and the cover element, such that air flowing through the intake space is guided around the substantially annular wall between the base element and the cover element.

19. The motor vehicle according to claim 7, wherein the annular wall is materially connected to the base element or is formed integrally therewith.

20. The motor vehicle according to claim 2, wherein the intake opening in the cover element is arranged substantially centrally in relation to a vehicle width, and in that the access opening is formed adjacent to the intake opening, wherein a spacing section of the cover element is formed between the intake opening and the access opening, which has an extension of less than 20 cm, in particular less than 5 cm, relative to a vehicle width direction.
